(19) United States
(12) Patent Application Publication
(10) Pub. No.: US 2016/0101965 A1
(43) Pub. Date: Apr. 14, 2016

(54) ELEVATOR WITH LOW OVERHEAD AND LOW PIT

(71) Applicants: Juan José FERNÁNDEZ, Madrid (ES); Francisco Luis SANZ, Madrid (ES); Agustin JIMÉNEZ-GONZÁLEZ, Madrid (ES); Juan QUILES, Rivas-Vaciamadrid (ES); Antonio de Miguel URQUIJO, Madrid (ES); Andrés MONZÓN, Madrid (ES); Ricardo CANO TORRES, Madrid (ES); Esmeralda DE DIEGO, Madrid (ES); Elviro LORENZO MICHELENA, Madrid (ES)

(72) Inventors: Juan Jose Fernandez, Madrid (ES); Francisco Luis Sanz, Madrid (ES); Agustin Jimenez-Gonzalez, Madrid (ES); Juan Quiles, Rivas-Vaciamadrid (ES); Antonio de Miguel Urquijo, Madrid (ES); Andres Monzon, Madrid (ES); Ricardo Cano Torres, Madrid (ES); Esmeralda De Diego, Madrid (ES); Elviro Lorenzo Michelena, Madrid (ES)

(21) Appl. No.: 14/895,315

(22) PCT Filed: Jun. 7, 2013
(86) PCT No.: PCT/ES2013/070372

§ 371 Date: Dec. 2, 2015

(51) Int. Cl. B66B 9/00; B66B 19/00; B66B 5/04

(52) U.S. Cl. CPC B66B 9/00; B66B 5/044; B66B 19/00

(57) ABSTRACT

Embodiments are directed to obtaining an elevator with low overhead space and low pit space by positioning a car of the elevator to have a space from a vertical wall of a hoist-way, mounting a governor in the space between the car and the wall, and mounting a sheave to the car, wherein the sheave is positioned in a projection of the car to the wall.

### BACKGROUND

In a given elevator system or environment, space may be limited. For example, it may be desirable to minimize the space consumed by an elevator system in order to allow the space to be used for other purposes.

A conventional elevator system might not be optimally designed for use as an elevator. For example, in some instances a space may have been initially intended to support a stairwell. In an effort to subsequently support an elevator application, the space may effectively be converted to an elevator hoist-way. Space may be at a premium when using legacy infrastructure to support an elevator.

### BRIEF SUMMARY

An embodiment of the disclosure is directed to a method for obtaining an elevator with low overhead space and low pit space, comprising: positioning a car of the elevator to have a space from a vertical wall of a hoist-way, mounting a governor in the space between the car and the wall, and mounting a sheave to the car, wherein the sheave is positioned in a projection of the car to the wall.

An embodiment of the disclosure is directed to an elevator system with a low overhead space and a low pit space, comprising: a car separated from a vertical wall of a hoist-way, a governor mounted in a space between the car and the wall, and a sheave positioned in a projection of the car to the wall.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 illustrates an exemplary elevator system in accordance with one or more embodiments of the disclosure;

FIG. 2 illustrates an exemplary elevator system for obtaining low overhead space and low pit space in accordance with one or more embodiments of the disclosure; and

FIG. 3 illustrates a flow chart of an exemplary method in accordance with one or more embodiments of the disclosure.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems and methods are described for reducing or minimizing an amount of space consumed by an elevator. In some embodiments, a clearance may be established between an elevator car and a wall in order to accommodate placement of a governor below a machine, which in turn may be lowered in a hoist-way.

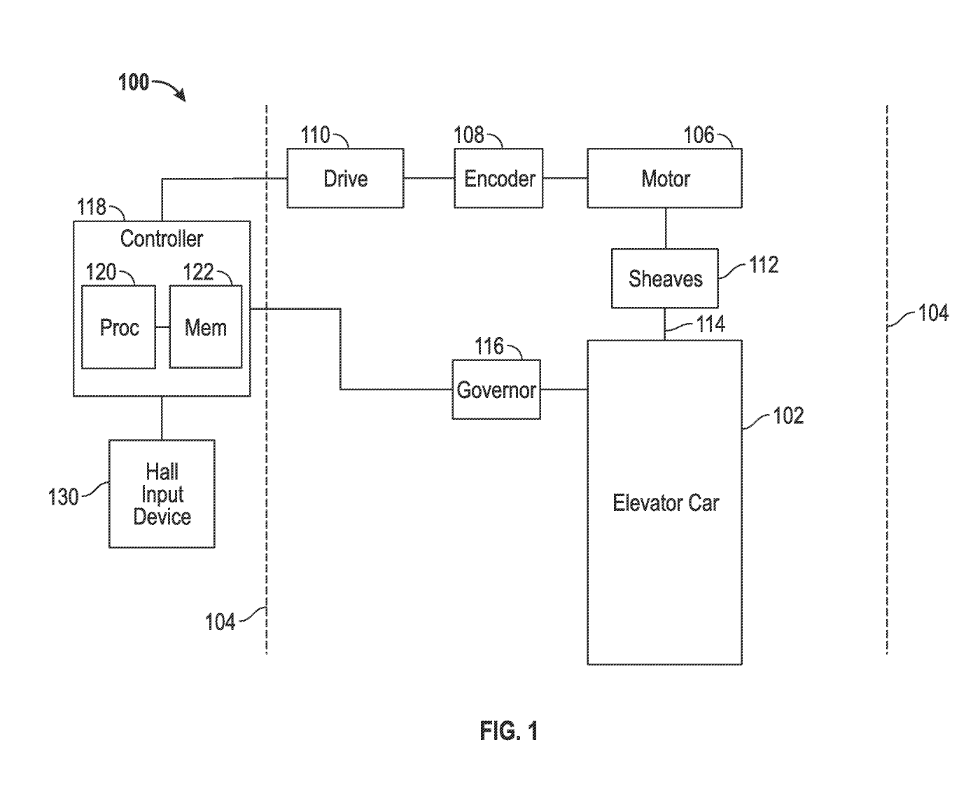

FIG. 1 illustrates a block diagram of an exemplary elevator system 100 in accordance with one or more embodiments. The organization and arrangement of the various components and devices shown and described below in connection with the elevator system 100 is illustrative. In some embodiments, the components or devices may be arranged in a manner or sequence that is different from what is shown in FIG. 1. In some embodiments, one or more of the devices or components may be optional. In some embodiments, one or more additional components or devices not shown may be included.

The system 100 may include an elevator car 102 that may be used to convey, e.g., people or items up or down an elevator shaft or hoist-way 104.

The elevator car 102 may be coupled to a motor 106. The motor 106 may provide power to the system 100. In some embodiments, the motor 106 may be used to propel or move the elevator car 102.

The motor 106 may be coupled to an encoder 108. The encoder 108 may be configured to provide a position of a machine or motor 106 as it rotates. The encoder 108 may be configured to provide a speed of the motor 108. For example, delta positioning techniques, potentially as a function of time, may be used to obtain the speed of the motor 108. Measurements or data the encoder 108 obtains from the motor 106 may be used to infer or determine a position of the elevator car 102.

The system 100 may include a drive 110. The drive 110 may be configured to control the speed of the elevator car 102 by controlling a speed of one or more sheaves 112. The sheaves 112 may be coupled to the elevator car 102 and/or the motor 106 by one or more tension members 114. A governor 116 may check the speed of the car 102 and stops mechanically and electrically the system 100 in case the governor 116 detects speeds in excess of (e.g., 30% greater than) a nominal speed.

The elevator car 102 may include, or be associated with, a controller 118. In some embodiments, the controller 118 may include at least one processor 120, and memory 122 having instructions stored thereon that, when executed by the at least one processor 120, cause the controller 118 to perform one or more acts, such as those described herein. In some embodiments, the processor 120 may be at least partially implemented as a microprocessor (uP), a digital signal processor, etc. In some embodiments, the memory 122 may be configured to store data. Such data may include data associated with the elevator car 102, selected destinations for the elevator car 102, etc.

In some embodiments, the elevator system 100 may include an input/output (I/O) interface that may be used by users or riders of the system 100 to gain access to the elevator 100 or the elevator car 102. As an example, the system 100 is shown in FIG. 1 as including a hall input device 130 that may serve as an interface for one or more users of the system 100. The hall input device 130 may be located in one or more locations, such as in a lobby or hallway located outside of the hoist-way 104. The hall input device 130 could be located in another location in some embodiments. The hall input device 130 may be coupled to the controller 118. The controller 118 may process one or more inputs received at the hall input device 130. The controller 118 may provide one or more commands to the hall input device 130, potentially based on the processing of the inputs received at the hall input device 130.

The system 100 is illustrative. In some embodiments, one or more of the devices or entities shown may be optional. In some embodiments, additional entities not shown may be included. In some embodiments, the entities may be organized or arranged in a manner different from what is shown. For example, the entities may be located in positions different from what is shown in FIG. 1. FIG. 1 is not necessarily drawn to scale.

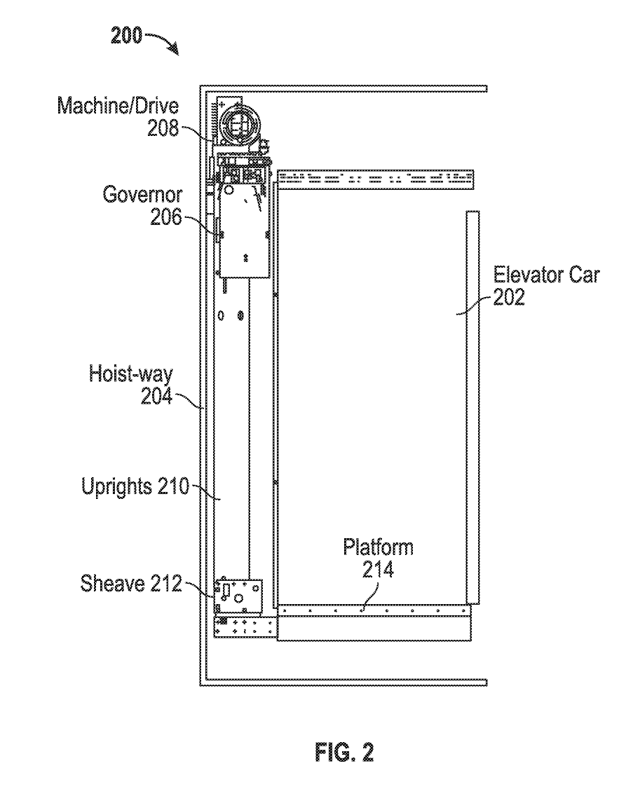

Turning now to FIG. 2, an exemplary elevator system 200 for obtaining low overhead space and low pit space is shown. In some embodiments, the system 200 may be implemented in connection with a cantilever carframe elevator.

In the system 200, an elevator car 202 is shown as being separated from a vertical wall of a hoist-way 204. The separation is used to provide enough space to fit a governor 206 in the space on the left of the FIG. 2, below a machine 208. A drive (e.g., drive 110 of FIG. 1) should be fitted in the same space. In some embodiments, the governor 206 may correspond to a car mounted governor (CMG), such that the governor 206 travels with the elevator car 202 as the elevator car 202 traverses the hoist-way 204. The governor 206 may be lowered relative to a conventional positioning in order to enable the elevator car 202 to reach a threshold amount (e.g., 500 mm) measured from the ceiling of the elevator car 202 to the top of the hoist-way 204.

The machine 208 is used to apply a traction force to one or more belts. The machine 208 may also be lowered relative to a conventional positioning for the machine 208 in order to facilitate a low overhead solution. In other words, in order to obtain a low overhead solution, the machine 208 may be lowered compared to a conventional or standard overhead solution.

In the lower part or portion of the system 200, the elevator car may reach a threshold amount (e.g., 400 mm) measured from the floor of the elevator car 202 to the bottom of the hoist-way 204. Enough space may be provided in this pit region to introduce any number of compensatory measures/devices, and some of the components may be designed for such a purpose. Uprights 210 may be reduced and a pit template may be prepared for this reduced pit.

One or more sheaves 212 may be included. A mechanic may have access to the sheave 212 in order to facilitate maintenance or service activities. The sheave 212 is contained in the projection of the car 202 to the wall of the hoist-way 204, in order to allow for a low pit configuration.

A platform 214 may be used to provide support for elevator car 202 or system 200.

The system 200 may be used to obtain an elevator that satisfies low overhead and low pit requirements simultaneously, without requiring an allocation of additional width in a hoist-way (e.g., hoist-way 104 or 204). In this respect, the system 200 may be used to retro-fit an elevator in a space that was not initially designed or intended to serve as an elevator.

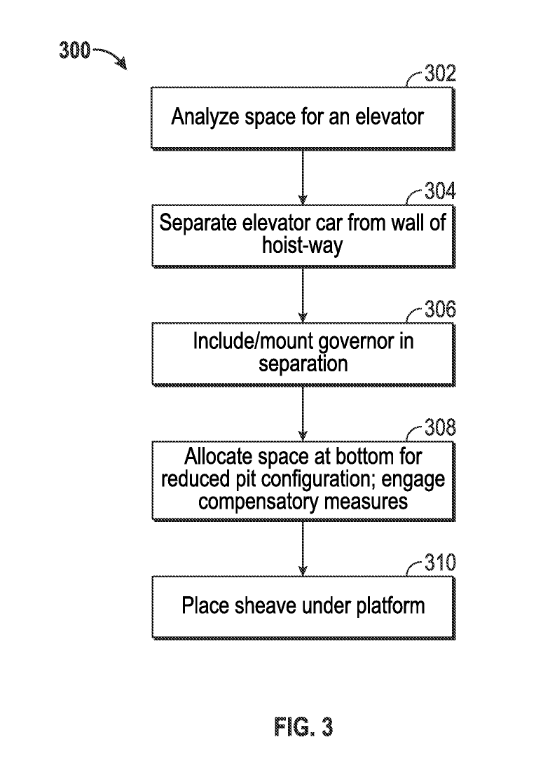

Turning now to FIG. 3, a flow chart of an exemplary method 300 is shown. The method 300 may be used to design, manufacture, or modernize an elevator with low overhead and low pit requirements, potentially without increasing the width of a hoist-way.

In block 302, a space for an elevator may be analyzed. For example, as part of block 302, the dimensions of a space for an elevator may be obtained. In some instances, the dimensions for the obtained space may be small, such that it might not be possible to incorporate conventional elevator design solutions.

In block 304, a car of the elevator may be separated from a wall of the hoist-way. The separation or clearance may be large enough to accommodate one or more components or devices (e.g., a governor). One or more thresholds may be used to account for component/device variation, such that any instance of a given component/device may be able to fit securely within the separation without contacting the wall of the hoist-way.

In block 306, a governor (e.g., governor 206 of FIG. 2) may be included in the separation/clearance between the elevator car and the wall of the hoist-way. As described above, the governor may be mounted to the elevator car, such that the governor may move with the elevator car as the elevator car traverses the hoist-way.

In block 308, space may be allocated at the bottom of the hoist-way to accommodate an elevator with a reduced pit. Compensatory measures may be taken, e.g., with respect to conventional elevator designs, to accommodate such a reduced pit.

In block 310, a sheave may be placed under a platform. The sheave may be located in a position such that a mechanic or service repairman or operator can obtain access to the sheave. The sheave may be contained in a projection of the elevator car to the hoistway wall to further facilitate a low pit configuration.

The method 300 is illustrative. In some embodiments, one or more of the blocks or operations (or portions thereof) may be optional. In some embodiments, the operations may execute in an order or sequence different from what is shown. In some embodiments, one or more additional operations not shown may be included.

In some embodiments, the minimum size of the hoistway is the car dimension plus 210 mm (in the machine/governor side) plus 60 mm (in the opposite side) and 50 mm (in the rear side) for a side-type elevator. For a rear configuration (the machine and the governor in the rear part of the hoistway), 210 mm minimum is needed in the rear part from the car to the wall and 60 mm in both sides of the car. In terms of overhead and pit, the minimum dimensions are: (1) overhead: Car height+500 mm, and (2) pit: 400 mm.

Embodiments may be tied to one or more particular machines. Elevator components or devices may be re-positioned or re-located about, e.g., an elevator car relative to conventional designs. An elevator with low overhead and low pit requirements may be obtained, potentially without increasing the width of a hoist-way.

In some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory having instructions stored thereon that, when executed by the one or more processors, cause the apparatus or system to perform one or more methodological acts as described herein. In some embodiments, one or more input/output (I/O) interfaces may be coupled to one or more processors and may be used to provide a user with an interface to an elevator system. Various mechanical components known to those of skill in the art may be used in some embodiments.

Embodiments may be implemented as one or more apparatuses, systems, and/or methods. In some embodiments, instructions may be stored on one or more computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method for obtaining an elevator with low overhead space and low pit space, comprising:
positioning a car of the elevator to have a space from a vertical wall of a hoist-way;
mounting a governor in the space between the car and the wall; and
mounting a sheave to the car, wherein the sheave is positioned in a projection of the car to the wall.

2. The method of claim 1, wherein the space between the car and the wall is selected to accommodate a dimension of the governor within a threshold so that the governor does not contact the wall.

3. The method of claim 1, wherein the governor is located below a machine that applies a traction force to one or more belts of the elevator.

4. The method of claim 3, further comprising:
minimizing the size of the machine.

5. The method of claim 1, wherein the hoist-way was not initially designed for use with an elevator.

6. An elevator system with a low overhead space and a low pit space, comprising:
a car separated from a vertical wall of a hoist-way;
a governor mounted in a space between the car and the wall; and
a sheave positioned in a projection of the car to the wall.

7. The elevator system of claim 6, wherein the space between the car and the wall is selected to accommodate a dimension of the governor within a threshold so that the governor does not contact the wall when the car traverses the hoist-way.

8. The elevator system of claim 6, wherein the governor is located below a machine that applies a traction force to one or more belts of the elevator.

9. The elevator system of claim 8, wherein the size of the machine is minimized.

10. The elevator system of claim 6, wherein the hoist-way was not initially sized for use as an elevator, and wherein a width of the hoist-way is established prior to an installation of the elevator system.
